(19) United States
(12) Patent Application Publication
(10) Pub. No.: US 2024/0176166 A1
(43) Pub. Date: May 30, 2024

(54) REMOVABLE VENTING SHIELD FOR EYEWEAR

(71) Applicant: Costa Del Mar, Inc., Daytona Beach, FL (US)

(72) Inventors: John SANCHEZ, San Clemente, CA (US); Casey J. LOPEZ, Huntington Beach, CA (US); Behnoud LAHIJI, Rancho Santa Margarita, CA (US)

(73) Assignee: Costa Del Mar, Inc., Daytona Beach, FL (US)

(21) Appl. No.: 18/524,906

(22) Filed: Nov. 30, 2023

Related U.S. Application Data
(60) Provisional application No. 63/429,046, filed on Nov. 30, 2022.

(51) Int. Cl. G02C 11/00; G02C 11/08

(52) U.S. Cl. CPC G02C 11/12; G02C 11/08

(57) ABSTRACT

Eyewear has a detachable, light-blocking shield including a vent which enables airflow for moisture management and wearer comfort. The eyewear's nosepad can include a nosepad vent, and a temple can include a fluid channel and temple vent for further facilitating airflow and moisture management. The vent of the shield can direct airflow into a region behind a lens of the eyewear and increase the volume of air flowing across an inner surface of the eyewear lens and through the fluid channel.

### CROSS-REFERENCE TO RELATED APPLICATION

This application claims the benefit of U.S. Provisional Application No. 63/429,046, filed Nov. 30, 2022, which is incorporated herein by reference in its entirety.

### BACKGROUND

Eyewear used to protect a wearer's eyes from sunlight is often implemented in environments with high temperature or humidity. When eyewear is worn in such environments, the lenses of the eyewear can fog and sweat can build up along portions of the eyewear contacting a wearer's head. Fog and sweat buildup can not only impede the vision of a wearer, but can also cause wearer discomfort. And when wearing sunglasses, light can enter a wearer's eyes through regions on the sides or tops of the lenses, either directly or by reflecting off inner surfaces of the lenses.

### BRIEF SUMMARY

Accordingly, there is a need to provide eyewear with light blocking features while managing moisture on the lenses and surfaces of the eyewear. Aspects of eyewear according to the present disclosure include a detachable, light-blocking shield including a vent enabling airflow. Also disclosed are a nosepad including a nosepad vent and a temple including a fluid channel and temple vent for facilitating airflow and moisture management.

In an aspect, the eyewear can include a frame, a lens comprising an inner surface facing an eye of a wearer in an as-worn configuration, and a temple attached to the frame. In an aspect, the eyewear can further include a shield removably attached to the frame. The shield can block light and/or wind and/or water, thus protecting the wearer's eyes. In an aspect, the shield can include a lower portion abutting a side portion of the frame and/or an upper portion abutting a top portion of the frame. In an aspect, the shield can further include a lower vent and/or an upper vent. The upper vent and/or lower vent can facilitate airflow over the inner surface of the lens, leading to decreased fogging. In an aspect, the shield can further include a depression to receive at least one of the frame or the temple.

In an aspect, the eyewear can further include a fluid channel extending along an inner surface of the temple, the inner surface of the temple facing the head of the wearer in an as-worn configuration. In an aspect, the fluid channel can include a bottom surface bordered by a wall. In an aspect, the wall can terminate at an opening disposed beyond an ear of the wearer in a direction away from the hinge. The fluid channel can provide a channel for sweat or other moisture to flow away from a forehead of the wearer beyond the ear of the wearer.

In an aspect, the temple can further include a temple vent. In an aspect, the temple vent can be disposed through the bottom surface of the fluid channel. The temple vent can facilitate airflow into the fluid channel of the temple, leading to sweat or other moisture wicking along the fluid channel.

In an aspect, the eyewear can further include a nosepad. In an aspect, the nosepad can include a nosepad vent. The nosepad vent can facilitate airflow over the inner surface of the lens.

In an aspect, the lower vent, the upper vent, the temple vent, and the nosepad vent can direct air across the inner surface of the lens and into the fluid channel. The upper vent, temple vent, and nosepad vent directing air across the inner surface of the lens and into the fluid channel can increase airflow through the regions between the lens and temple and the wearer's head, leading to decreased fogging and increased wearer comfort.

In an aspect, the upper vent and the lower vent can increase the volume of air flowing across the inner surface of the lens and through the fluid channel, for example according to the Venturi effect.

In an aspect, the eyewear can further include an anti-skid portion. In an aspect, the anti-skid portion can be disposed on a top portion of the eyewear. In an aspect, the anti-skid portion can extend beyond the top portion of the eyewear. In an aspect, the coefficient of friction between the anti-skid portion and a surface can be greater than the coefficient of friction between the top portion of the eyewear and the surface. The anti-skid portion can prevent the eyewear from slipping off a surface, for example the surface of a boat, and being lost, for example being lost in water surrounding the boat. In an aspect, the upper portion of the shield can include the anti-skid portion.

In an aspect, the frame can further include an aperture. In an aspect, the shield can include a pin to detachably attach to the aperture such that the pin is rotatable within the aperture. The pin and aperture can secure the shield to the frame while allowing the shield to rotate between an extended position and a closed position.

In an aspect, the frame can further include a slot. In an aspect, the shield can further include a hook to releasably engage the slot. The slot and the hook can releasably secure the shield in the extended position.

In an aspect, the lower vent can be defined by a surface of the lower portion of the shield and an adjacent surface of the side portion of the frame. In an aspect, the upper vent can be defined by a surface of the upper portion of the shield and an adjacent surface of the top portion of the frame. The geometry of the surfaces surrounding the lower vent and the upper vent can increase airflow while directing light, fluid, or projectiles away from a wearer's eye and the inner surface of the lens.

In an aspect, the temple can be attached to the frame by a hinge. In aspect, the shield can further include a recess. In an aspect, the recess can accommodate the temple when the temple is rotated relative to the frame. The recess can allow for independent rotation of the shield and the temple.

In an aspect, the height of the lower vent can be greater than about one-tenth the height of the lens. In an aspect, the width of the upper vent can be greater than about one-tenth the width of the lens. The lower vent and the upper vent can provide increased airflow.

In an aspect, a method of manufacturing eyewear with a removable side shield can include forming a frame, forming a temple, and attaching the temple to the frame. In an aspect, the method can further include forming a shield of flexible material. Forming a shield of flexible material can provide for increased light blocking, protecting a wearer's eyes from direct or reflected sunlight. In an aspect, the shield can include a vent. The vent can facilitate airflow over the inner surface of the lens, leading to decreased fogging. In an aspect, the shield can further include a depression to receive at least one of the frame or the temple. In an aspect, the method can further include attaching the shield such that the shield abuts a side portion of the frame. The shield abutting a side portion of the frame can increase light blocking.

In an aspect, forming the shield can include injection molding the shield.

In an aspect, the eyewear can include a frame, a lens comprising an inner surface facing an eye of a wearer in an as-worn configuration, and a temple attached to the frame. In an aspect, the eyewear can further include a shield removably attached to the frame or the temple. The shield can increase light blocking, protecting a wearer's eyes from direct or reflected sunlight. In an aspect, the shield can form a vent. The vent can facilitate airflow over the inner surface of the lens, leading to decreased fogging.

In an aspect, the shield can abut a side portion of the frame. The shield abutting a side portion of the frame can increase light blocking.

In an aspect, the temple can be attached to the frame by a hinge.

In an aspect, the shield can be configured to rotate with respect to the frame between an extended position and a closed position. The shield being configured to rotate with respect to the frame can allow for closing the shields to store the eyewear.

In an aspect, the eyewear can further include a fluid channel extending along an inner surface of the temple, the inner surface of the temple facing the head of the wearer in an as-worn configuration. In an aspect, the fluid channel can include a bottom surface bordered by a wall. In an aspect, the wall can terminate at an opening disposed beyond an ear of the wearer in a direction away from the hinge. The fluid channel can provide a channel for sweat or other moisture to flow away from a forehead of the wearer beyond the ear of the wearer.

In an aspect, the temple can further include a temple vent. In an aspect, the temple vent can be disposed through the bottom surface of the fluid channel. The temple vent can facilitate airflow into the fluid channel of the temple, leading to sweat or other moisture wicking along the fluid channel.

In an aspect, the eyewear can further include a nosepad. In an aspect, the nosepad can include a nosepad vent. The nosepad vent can facilitate airflow over the inner surface of the lens.

In an aspect, the vent, the temple vent, and the nosepad vent can direct air across the inner surface of the lens and into the fluid channel. The vent, temple vent, and nosepad vent directing air across the inner surface of the lens and into the fluid channel can increase airflow through the regions between the lens and the temple and the wearer's head, leading to decreased fogging and increased wearer comfort.

In an aspect, the vent can increase the volume of air flowing across the inner surface of the lens and through the fluid channel, for example according to the Venturi effect.

In an aspect, the eyewear can further include an anti-skid portion. In an aspect, the anti-skid portion can be disposed on a top portion of the eyewear. In an aspect, the anti-skid portion can extend beyond the top portion of the eyewear. In an aspect, the coefficient of friction between the anti-skid portion and a surface can be greater than the coefficient of friction between the top portion of the eyewear and the surface. The anti-skid portion can prevent the eyewear from slipping off a surface, for example the surface of a boat, and being lost, for example being lost in water surrounding the boat.

In an aspect, the shield can further include an upper portion abutting at least one of a top portion of the frame or a top portion of the temple. In an aspect, the upper portion can include the anti-skid portion.

In an aspect, the frame or the temple can further include an aperture. In an aspect, the shield can further include a pin to detachably attach to the aperture such that the pin is rotatable within the aperture. The pin and aperture can secure the shield to the frame while allowing the shield to rotate between an extended position and a closed position.

In an aspect, the frame or the temple can further include a slot. In an aspect, the shield can further include a hook to releasably engage the slot. The slot and the hook can releasably secure the shield in the extended position.

In an aspect, the vent can be defined by a surface of the shield and an adjacent surface of the side portion of the frame. The geometry of the surfaces surrounding the vent can increase airflow while directing light, fluid, or projectiles away from a wearer's eye and the inner surface of the lens.

In an aspect, the height of the vent can be greater than about one-tenth the height of the lens. The vent can provide increased airflow.

### BRIEF DESCRIPTION OF THE FIGURES

The accompanying figures, which are incorporated herein and form a part of the specification, illustrate the present disclosure and, together with the description, further serve to explain the principals thereof and to enable a person skilled in the pertinent art to make and use the same. Aspects of the present disclosure are best understood from the following detailed description when read with the accompanying figures. It is noted that features may not be drawn to scale. In fact, the dimensions of the features may be arbitrarily increased or reduced for clarity of discussion. In the drawings:

FIG. 1 is a perspective view of eyewear, according to an aspect.

FIG. 1A is a detail view of the eyewear shown in FIG. 1, according to an aspect.

FIG. 2 is a section view of the eyewear shown in FIG. 1 along line 2-2, according to an aspect.

FIG. 3 is a section view of the eyewear shown in FIG. 1 along line 3-3, according to an aspect.

FIG. 4A is an exploded view of a shield for eyewear, according to an aspect.

FIG. 4B is a perspective view of a shield for eyewear, according to an aspect.

FIG. 5 is a section view of the eyewear shown in FIG. 1 along line 2-2, with a shield removed, according to an aspect.

FIG. 6 is a section view of the eyewear shown in FIG. 1 along line 2-2, with a shield attached, according to an aspect.

FIG. 7 is a perspective view of eyewear, according to an aspect.

FIG. 7A is a detail view of the eyewear shown in FIG. 7, according to an aspect.

FIG. 8 is a section view of the eyewear shown in FIG. 7 along line 8-8, according to an aspect.

FIG. 9 is a section view of the eyewear shown in FIG. 7 along line 9-9, according to an aspect.

FIG. 10 is a perspective view of a half of eyewear, according to an aspect.

FIG. 11 is a perspective view of a shield for eyewear, according to an aspect.

### DETAILED DESCRIPTION

In the following detailed description, aspects can be described with respect to a particular half of the eyewear illustrated in the accompanying figures. It should be understood that eyewear can include two halves including components (e.g., lenses, temples, or shields) that are substantially mirror images of one another. Therefore, aspects described with respect to one half of the eyewear disclosed should be understood to disclose aspects that are functionally and structurally identical for a corresponding second half including the aspects described.

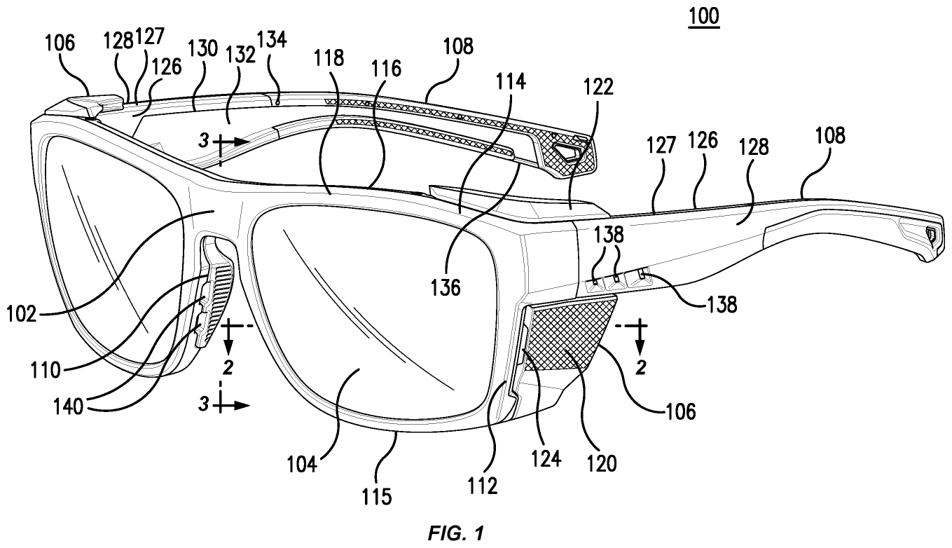

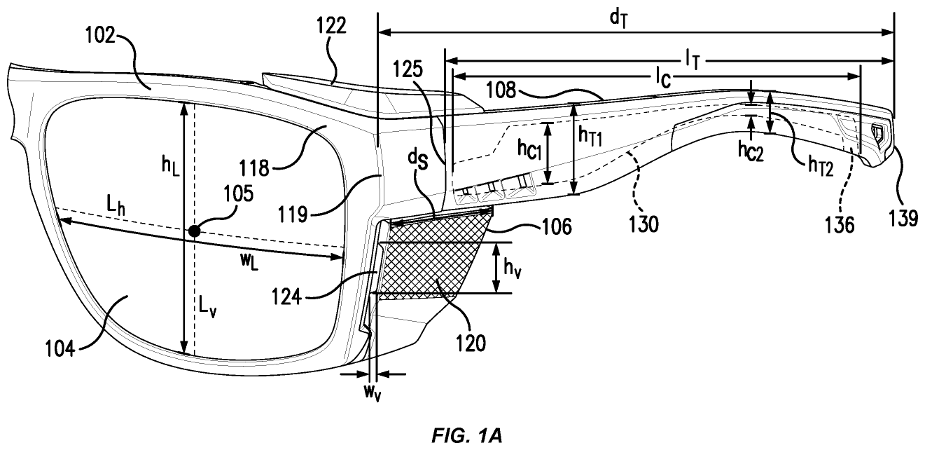

FIG. 1 shows eyewear 100. In an aspect, eyewear 100 can be sunglasses used to protect a wearer's eyes from direct or reflected sunlight. Eyewear 100 can include a frame 102 and one or more lenses 104. Eyewear 100 can further include one or more shields 106, temples 108, and nosepad 110. Frame 102 can include a side portion 112, a top portion 114, a bottom portion 115, an inner surface 116, and an outer surface 118.

As shown in FIG. 1, eyewear 100 can include two shields 106 each disposed at opposite lateral sides of frame 102. Each shield 106 can block light, wind, or projectiles from entering a wearer's eye. Blocked light can include light that would have entered the wearer's eye directly or upon reflection off the inner surface of lens 104 (i.e., the surface of lens 104 facing an eye of a wearer when eyewear 100 is worn).

Shield 106 can include a lower portion 120. In an aspect, lower portion 120 can abut side portion 112 of frame 102. In an aspect, shield 106 can further include an upper portion 122. In an aspect, upper portion 122 can abut top portion 114 of frame 102. In another aspect, shield 106 can include lower portion 120 without upper portion 122 or upper portion 122 without lower portion 120.

Shield 106 can further include a vent 124. Vent 124 can facilitate airflow over the inner surface of lens 104, leading to decreased fogging. Further, vent 124 can facilitate airflow in the region between lens 104 and a wearer's head, increasing moisture management and wearer comfort. Vent 124 can be disposed in lower portion 120 of shield 106.

In an aspect, vent 124 can be a polygon, such as a trapezoid. In another aspect, vent 124 can be rectangular. In another aspect, vent 124 can be ovular. In another aspect, vent 124 can be circular.

Each temple 108 can secure eyewear 100 to the face of a wearer by extending over an ear of the wearer. In an aspect, temple 108 can be attached to frame 102 by a hinge such that temple 108 can move, such as by rotation, between an extended position in which temple 108 extends substantially perpendicularly from frame 102 and a closed position in which temple 108 extends substantially parallel to frame 102. In another aspect, temple 108 can be a hingeless temple integral with frame 102. In another aspect, temple 108 can be attached to frame 102 by a snap fit or friction fit.

Temple 108 can include an inner surface 126, a top portion 127, and an outer surface 128. Temple 108 can further include a channel 130 extending along inner surface 126. Channel 130 can be a fluid channel. Channel 130 can include a bottom surface 132 bordered by a wall 134. In an aspect, wall 134 can terminate at an opening 136 disposed beyond an ear of the wearer in a direction distal from frame 102 when eyewear 100 is worn.

Each temple 108 can further include temple vents 138 to direct airflow down channel 130. Directing airflow down channel 130 can serve a moisture-wicking function. Further, temple vents 138 can facilitate airflow in the region between temple 108 and a wearer's head, increasing wearer comfort.

Temple vents 138 can be disposed through bottom surface 132 such that temple vents 138 extend from outer surface 128 to inner surface 126 of temple 108. While FIG. 1 shows three temple vents 138 per temple 108, fewer or additional temple vents 138, such as one, two, four, five, or six temple vents 138 per temple 108 can be used. Temple vents 138 can be angled or shaped such that light, fluid, or projectiles passing through temple vents 138 are directed away from a wearer's eye and the inner surface of lens 104. Directing light away from the inner surface of lens 104 can prevent reflected light from entering a wearer's eye.

In an aspect, temple vents 138 can be polygons, such as trapezoids. In another aspect, temple vents 138 can be rectangular. In another aspect, temple vents 138 can be ovular. In another aspect, temple vents 138 can be circular. In an aspect, temple vents 138 can be recessed in inner surface 126 and outer surface 128 such that the openings defining temple vents 138 are below the planes of inner surface 126 and outer surface 128. In another aspect, the openings defining temple vents 138 can be substantially co-planar with inner surface 126 and/or outer surface 128.

Each nosepad 110 can support eyewear 100 on the nose of a wearer. Nosepad 110 can include nosepad vents 140 to facilitate airflow over the inner surface of lens 104, leading to decreased fogging. Further, nosepad vents can facilitate airflow in the region between lens 104 and a wearer's head, increasing moisture management and wearer comfort. While FIG. 1 shows two nosepad vents 140 per nosepad 110, fewer or additional nosepad vents 140, such as one, three, or four nosepad vents 140 per nosepad 110 can be used.

In an aspect, nosepad vents 140 can be defined by a surface of nosepad 110 and inner surface 116 of frame 102. In another aspect, nosepad vents 140 can be formed entirely within frame 102 or entirely within nosepad 110. In an aspect, nosepad vents 140 can be ovular. In another aspect, nosepad vents 140 can be polygons, such as trapezoids. In another aspect, nosepad vents 140 can be rectangular. In another aspect, nosepad vents 140 can be circular.

FIG. 1A shows example dimensions (e.g., d_{T}, d_{S}, etc.) of the components of eyewear 100. As shown in FIG. 1A, outer surface 118 of frame 102 can include an edge 119. In an aspect, edge 119 can mark the transition between a portion of frame 102 substantially parallel with lens 104 and a portion of frame 102 substantially parallel with temple 108. As shown in FIG. 1A, eyewear 100 can further include a joining line 125. In an aspect, joining line 125 can mark the juncture of frame 102 and temple 108. As shown in FIG. 1A, temple 108 can further include a distal end 139.

A distance d_{T} can be the distance between edge 119 and distal end 139. A distance dₛ can be the distance shield 106 extends from frame 102. In an aspect, d_{S} can be greater than about one-tenth d_{T}, such as about one-third to about one-tenth d_{T}, about one-fourth to about one-eighth d_{T}, or about one-fifth to about one-sixth d_{T}.

The lens height h_{L} can be the length of a vertical line L_{V} extending through the center point 105 of lens 104. In an aspect, the vent height h_{V} can be greater than about one-tenth h_{L}, such as greater than about one-eighth h_{L}, greater than about one-sixth h_{L}, greater than about one-fourth h_{L}, greater than about one-third h_{L}, or greater than about one-half h_{L}.

The lens width w_{L} can be the length of a horizontal line Lₕ extending through the center point 105 of lens 104. In an aspect, the vent width w_{V} can be greater than about one-fortieth w_{L}, such as greater than about one-thirtieth w_{L}, greater than about one-twenty-fifth w_{L}, greater than about one-twentieth w_{L}, or greater than about one-fifteenth w_{L}.

The temple length l_{T} can be the distance between joining line 125 and distal end 139. In an aspect, the channel length l_{C} can be greater than one-half l_{T}, such as about two-thirds l_{T} to about eleven-twelfths l_{T}, about three-fourths l_{T} to about nine-tenths l_{T}, or about four-fifths l_{T} to about seven-eighths l_{T}.

In an aspect, the channel height h_{C} at a point can be greater than one-third the temple height h_{T} at substantially the same point, such as about one-third to about nine-tenths h_{T}, about one-half to about nine-tenths h_{T}, about two-thirds to about eight-ninths h_{T}, or about three-fourths to about seven-eighths h_{T}.

In an aspect, the shape of channel 130 can be similar to the shape of temple 108. In an aspect, channel 130 can taper such that channel height h_{C} at its widest point (h_{C1}) is larger than its height at its narrowest point (h_{C2}). In an aspect, the ratio of h_{C1} and h_{C2} can be greater than about 2, such as about 2 to about 5, or about 3 to about 4. In another aspect, h_{C} can be substantially constant.

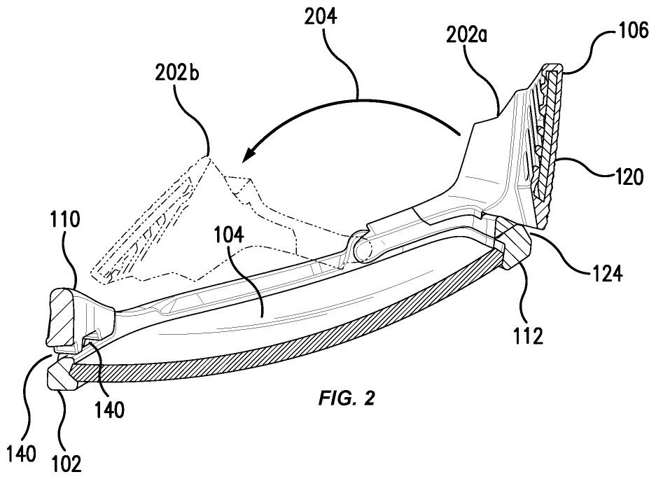

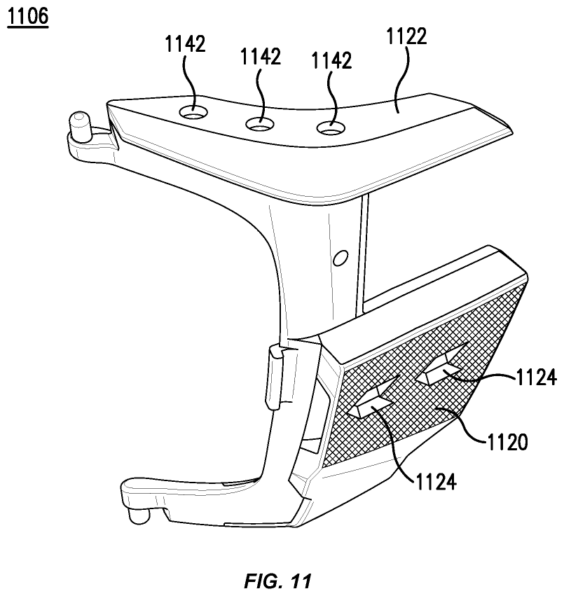

FIG. 2 shows a section of frame 102 with shield 106 attached. In an aspect, vent 124 can be defined by a surface of lower portion 120 and an adjacent surface of side portion 112 of frame 102. In another aspect, vent 124 can be formed entirely within shield 106, as shown in FIG. 11 (depicting lower vents 1124 formed entirely within shield 1106).

Vent 124 can be angled or shaped such that light, fluid, or projectiles passing through vent 124 are directed away from a wearer's eye and the inner surface of lens 104. Directing light away from the inner surface of lens 104 can prevent reflected light from entering a wearer's eye.

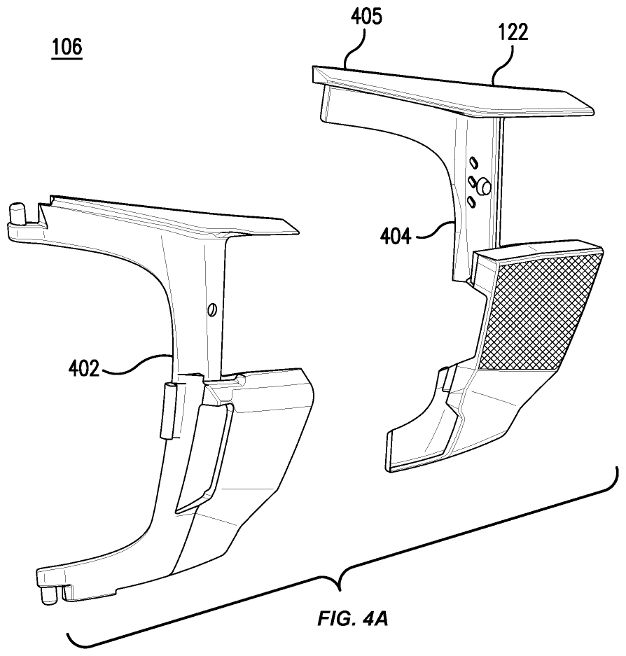

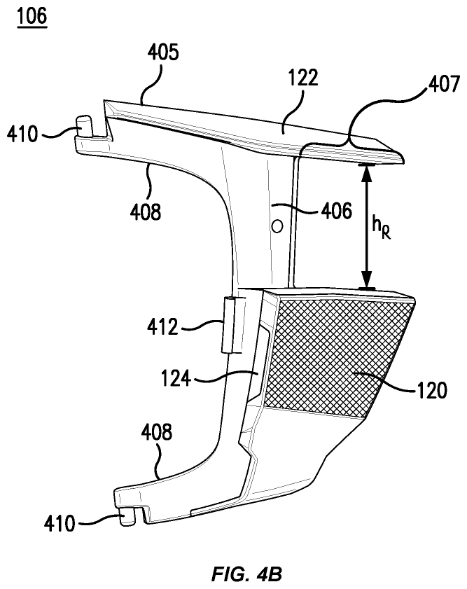

As discussed in more detail with respect to FIGS. 4-6, shield 106 can rotate between an extended position 202a and a closed position 202b, for example, along an arc 204. Closing shield 106 can allow eyewear 100 to be stored.

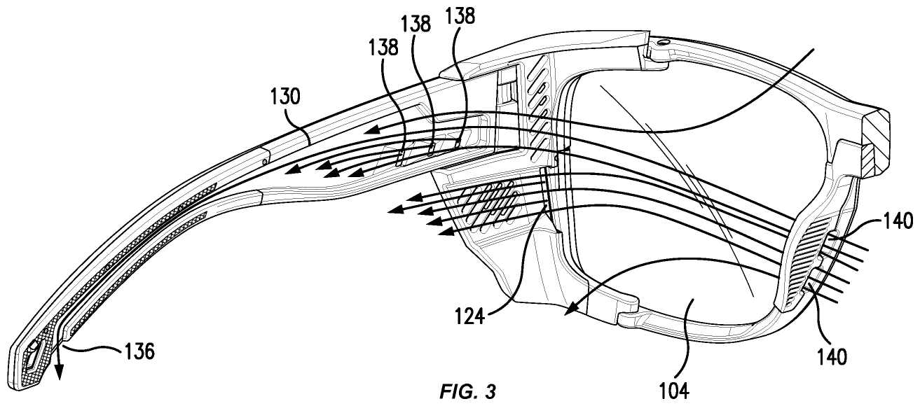

FIG. 3 shows an example pattern of airflow across eyewear 100, facilitated by vent 124, temple vents 138, and nosepad vents 140. It should be understood that FIG. 3 only shows one possible pattern of airflow across eyewear 100, and other possible patterns of airflow exist depending on conditions such as wearer movement, wind direction and intensity, etc.

Vent 124, temple vents 138, and nosepad vents 140 can direct air across the inner surface of lens 104 and into channel 130. For example, nosepad vents 140 can direct air into the region behind lens 104 and toward the inner surface of lens 104. Vent 124 can direct airflow into the region behind lens 104, contributing to a current of air across the inner surface of lens 104. For example, vent 124 can contribute to a current of air across the inner surface of lens 104 by reducing the pressure of air flowing through vent 124, for example according to the Venturi effect. This pressure decrease in the area surrounding vent 124 can pull air across the inner surface of lens 104, thereby increasing the volume of air flowing across the inner surface of lens 104. Further, air directed across the inner surface of lens 104 can flow across shield 106 and/or into channel 130, thereby increasing the volume of air flowing through channel 130.

Additionally, temple vents 138 can direct airflow into the region behind lens 104 (e.g., into channel 130), further contributing to the current of air across the inner surface of lens 104, for example according to the Venturi effect. Airflow directed into channel 130 can wick moisture along channel 130 and exit at opening 136.

FIG. 4A shows an exploded view of shield 106. In an aspect, shield 106 can be injection molded. For example, shield 106 can be two-shot injection molded. FIG. 4A shows an inner portion 402 and an outer portion 404 of shield 106. In an aspect, inner portion 402 can be injection molded prior to outer portion 404 being overmolded on inner portion 402. In an aspect, inner portion 402 and outer portion 404 can be formed from different materials. In an aspect, outer portion 404 can be formed from a more flexible material than inner portion 402. In another aspect, shield 106 can be formed from a single material.

As shown in FIG. 4A, outer portion 404 can include upper portion 122 of shield 106. In an aspect, upper portion 122 can include an anti-skid portion 405 configured to reduce slipping on a surface in contact with upper portion 122. For example, anti-skid portion 405 can contact a surface (e.g., a fiberglass surface) when a user places eyewear 100 upside-down on the surface. Upper portion 122 can be a material with a durometer rating configured to increase the coefficient of friction between eyewear 100 and a surface. For example, the coefficient of friction between the material of upper portion 122 and a surface can be greater than the coefficient of friction between top portion 114 of frame 102 and the surface. In an aspect, the material of upper portion 122 can have a durometer rating of about 0 to about 100 Shore A, such as about 20 Shore A to about 90 Shore A, about 30 Shore A to about 85 Shore A, about 40 Shore A to about 80 Shore A, about 50 Shore A to about 75 Shore A, or about 60 Shore A to about 70 Shore A.

In another aspect, anti-skid portion 405 can be disposed on eyewear 100 separately from upper portion 122 of shield 106. For example, anti-skid portion 405 can be disposed apart from upper portion 122 or instead of upper portion 122 on a top portion of eyewear 100 generally, such as top portion 114 of frame 102 and/or top portion 127 of temple 108. In such an aspect, anti-skid portion 405 can be a material with a durometer rating within the ranges described above for upper portion 122. The coefficient of friction between the material of anti-skid portion 405 and a surface can be greater than the coefficient of friction between top portion 114 of frame 102 and/or top portion 127 of temple 108 and the surface.

Anti-skid portion 405 can extend beyond the top portion of eyewear 100 (e.g., top portion 114 of frame 102 and/or top portion 127 of temple 108) such that anti-skid portion 405, rather than frame 102 or temple 108, contacts a surface when eyewear 100 is placed upside-down on the surface.

FIG. 4B shows shield 106, formed, in an aspect, from inner portion 402 and outer portion 404. Shield 106 can include a depression 406 to receive frame 102 and/or temple 108. Depression 406 can extend at least between lower portion 120 and upper portion 122. In an aspect, depression 406 can receive frame 102 such that depression 406 can abut inner surface 116 of frame 102 when shield 106 is attached to eyewear 100. In another aspect, such as if temple 108 is not configured to rotate with respect to shield 106, depression 406 can receive frame 102 and/or temple 108 such that depression 406 can abut inner surface 126 of temple 108 in addition to or instead of inner surface 116 of frame 102.

FIG. 4B shows depression 406 facing outward from shield 106 such that shield 106 can receive and abut inner surfaces (e.g., inner surfaces 116 and/or 126 of frame 102 and temple 108) of eyewear 100 when attached. In another aspect, depression 406 can face inward from shield 106 such that shield 106 can receive and abut outer surfaces (e.g., outer surfaces 118 and/or 128) of eyewear 100 when attached.

In an aspect, the depth of depression 406 can be substantially equal to the thickness of frame 102 and/or temple 108 such that, when shield 106 is attached to eyewear 100, lower portion 120 of shield 106 is substantially co-planar with outer surface 118 of frame 102 and/or outer surface 128 of temple 108 (as shown in FIGS. 1 and 1A). In another aspect, the depth of depression 406 can be less than the thickness of frame 102 and/or temple 108 such that lower portion 120 of shield 106 is recessed from outer surface 118 and/or outer surface 128. In another aspect, the depth of depression 406 can be greater than the thickness of frame 102 and/or temple 108 such that lower portion 120 of shield 106 extends beyond the planes of outer surface 118 and/or outer surface 128.

Shield 106 can further include a recess 407. Recess 407 can accommodate temple 108 when temple 108 is rotated relative to shield 106. Therefore, shield 106 and temple 108 can be rotated independently. For example, temple 108 can be moved to a closed position, rotating into recess 407, while shield 106 can remain in extended position 202a. Allowing shield 106 and temple 108 to rotate independently of one another can prevent damage to shield 106 caused by closing temple 108 over shield 106.

Recess height h_{R} can be greater than the temple height h_{T} (e.g., h_{T1}) to allow temple 108 to rotate into recess 407.

In an aspect, h_{R} can taper. In an aspect, h_{R} tapering can correspond to h_{T} tapering. In another aspect, h_{R} can be substantially constant.

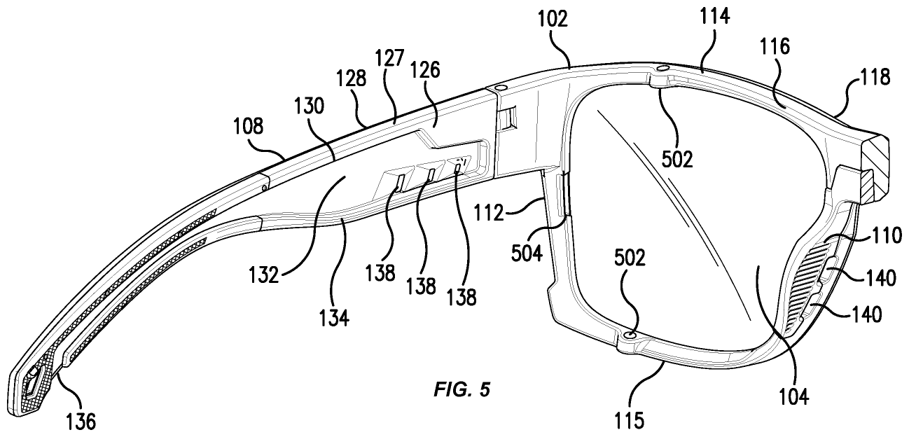

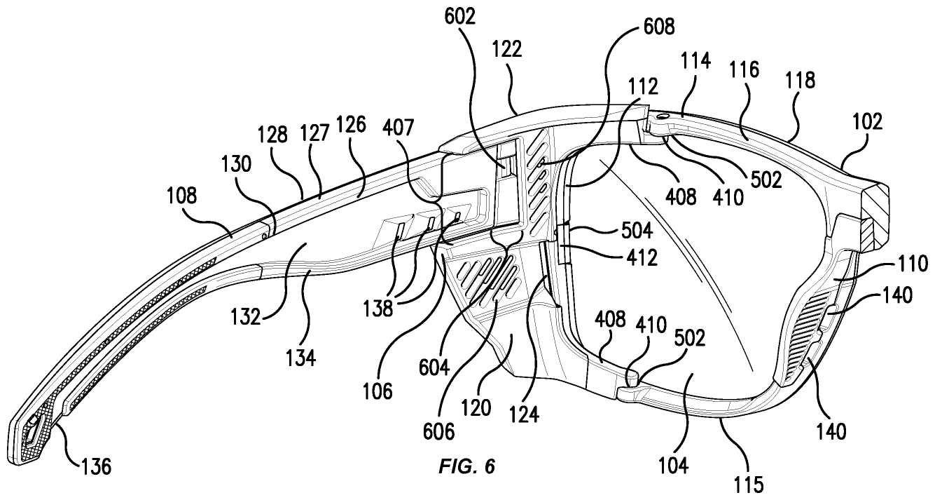

Shield 106 can further include prongs 408 to secure shield 106 to frame 102. Prongs 408 can include pins 410 disposed at ends of prongs 408 to detachably attach to complementary apertures in frame 102, as discussed in more detail below with respect to FIGS. 5 and 6.

In an aspect, pins 410 can have cylindrical cross-sections, allowing pins 410 to rotate within complementary apertures in frame 102 when shield 106 is attached to frame 102. In an aspect, pins 410 can taper in a direction away from their bases, providing for a friction fit within complementary apertures in frame 102. In such an aspect, a user moving shield 106 between extended position 202a and closed position 202b can experience stiffness of movement between the extended position 202a and closed position 202b. In another aspect, pins 410 can have polygonal, such as rectangular, lateral cross sections, securing shield 106 in a single configuration with respect to frame 102.

In an aspect, pins 410 can be hooks to detachably attach to complementary slots in frame 102. In another aspect, pins 410 can be a magnet or magnets to detachably attach to a complementary magnet or magnets in frame 102.

Shield 106 can further include a hook 412 to releasably engage a complimentary slot on frame 102, as discussed in more detail below with respect to FIGS. 5 and 6. Hook 412 can provide a snap fit securing shield 106 in extended position 202a. In an aspect, hook 412 can be a protrusion including an undercut, as shown in FIG. 4B. In another aspect, hook 412 can be a pin or magnet to releasably engage a complimentary aperture or magnet on frame 102.

In an aspect, shield 106 can include an attachment (e.g., pins 410 and hook 412) to attach to a complementary attachment disposed on frame 102, as described above. In another aspect, shield 106 can include an attachment (e.g., pins 410 and hook 412) to attach to a complementary attachment disposed on temple 108.

FIG. 5 shows a complementary attachment disposed on frame 102. For example, frame 102 can include apertures 502 for receiving pins 410. In an aspect, apertures 502 can extend through top portion 114 and bottom portion 115 of frame 102. In another aspect, apertures 502 can extend only partially through top portion 114 and bottom portion 115 of frame 102. In an aspect, apertures 502 can be cylindrical, allowing pins 410 to rotate within apertures 502. In another aspect, such as if pins 410 have polygonal lateral cross sections, apertures 502 can have polygonal lateral cross sections, such as rectangular lateral cross sections, securing shield 106 in a single configuration with respect to frame 102. In another aspect, such as if pins 410 are hooks, apertures 502 can be slots to detachably receive the hooks. In another aspect, such as if pins 410 are magnets, apertures 502 can be magnets or a ferromagnetic material to detachably attach to the magnets.

Frame 102 can further include slot 504 to receive hook 412. Slot 504 and hook 412 can provide a snap fit securing shield 106 in extended position 202a. In an aspect, slot 504 can include an undercut in side portion 112 of frame 102. In another aspect, such as if hook 412 is a pin or a magnet, slot 504 can be an aperture or a magnet to releasably engage the pin or magnet replacing hook 412.

While FIG. 5 shows an attachment in frame 102, an attachment, such as apertures 502 and slot 504 (or alternative attachment means discussed above) can be included on temple 108 rather than frame 102. In such an aspect, pins 410 and slot 504 (or alternative attachment means discussed above) can be included on portions of shield 106 abutting temple 108.

FIG. 5 further shows lens 104 and bottom portion 115 of frame 102. In an aspect, lens 104 can include a hydrophobic coating for repelling or dispersing fog or other moisture. Bottom portion 115 can include a beveled edge, as shown in FIG. 5, to remove moisture from the hydrophobic coating of lens 104.

FIG. 6 shows shield 106 attached to frame 102. As shown in FIG. 6, pins 410 can be inserted into apertures 502 and hook 412 can engage slot 504. To remove shield 106 from extended position 202a and rotate shield 106 toward closed position 202b, a user can apply pressure to outer portions of shield 106 to cause hook 412 to disengage from slot 504. To detach shield 106 from frame 102, a user can apply pressure to prongs 408 to cause prongs 408 to flex inwardly, detaching pins 410 from apertures 502.

While FIGS. 4, 5, and 6 show pins 410 on shield 106 and apertures 502 on frame 102, in another aspect, pins 410 can be disposed on frame 102 while apertures 502 can be disposed on shield 106. Further, while FIGS. 4, 5, and 6 show hook 412 on shield 106 and slot 504 on frame 102, in another aspect, hook 412 can be disposed on frame 102 while slot 504 can be disposed on shield 106.

In addition, FIG. 6 shows that eyewear 100 can include a hinge 602 for attaching temple 108 to frame 102. Hinge 602 can allow temple 108 to rotate between an extended position in which temple 108 extends substantially perpendicularly from frame 102 and a closed position in which temple 108 extends substantially parallel to frame 102. In an aspect, hinge 602 can be a spring-loaded hinge. In another aspect, hinge 602 can be a springless, or standard, hinge. As shown in FIG. 6, to allow temple 108 to rotate into recess 407, recess 407 can extend from a position adjacent a joining region 604 of temple 108 and frame 102.

As shown in FIG. 6, shield 106 can further include a lower slit array 606 and an upper slit array 608. In an aspect, lower slit array 606 and upper slit array 608 can include diagonally extending depressions disposed in shield 106. In another aspect, lower slit array 606 and upper slit array 608 can include laterally or vertically extending depressions disposed in shield 106. In an aspect, lower slit array 606 and/or upper slit array 608 can include holes through outer portion 404 of shield 106, which can be used to secure outer portion 404 with respect to inner portion 402 during overmolding.

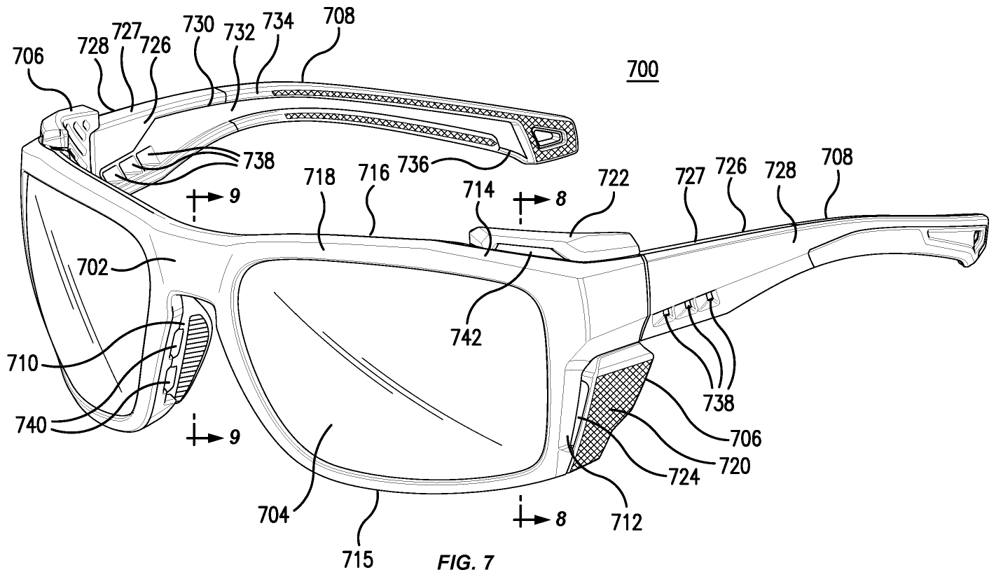

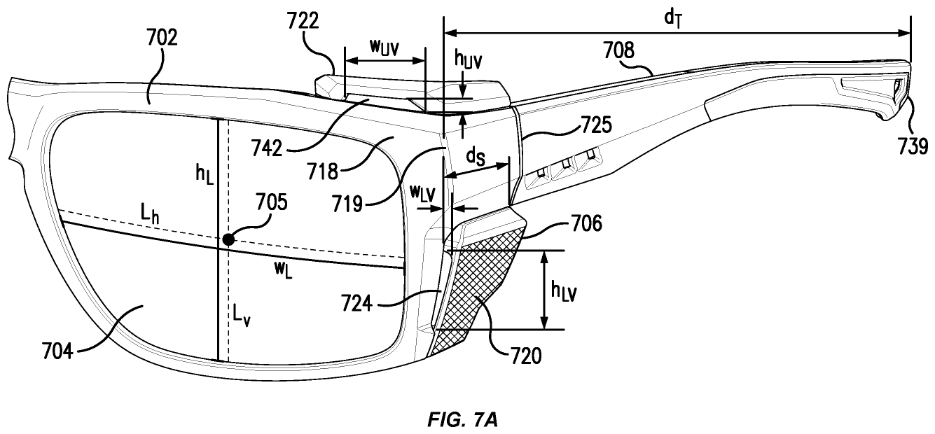

FIG. 7 shows eyewear 700. In an aspect, eyewear 700 can be sunglasses to protect a wearer's eyes from direct or reflected sunlight. Eyewear 700 can be substantially the same as eyewear 100 and shield 706 can be substantially the same as shield 106. For example, eyewear 700 and shield 706 can include substantially the same shield attachment features as those described above for eyewear 100 and shield 106 with reference to FIGS. 4B, 5, and 6 and the corresponding disclosure. In addition, shield 706 can include an upper vent 742. Upper vent 742 can facilitate airflow over the inner surface of lens 704, leading to decreased fogging. Further, upper vent 742 can facilitate airflow in the region between lens 704 and a wearer's head, increasing moisture management and wearer comfort. Upper vent 742 can be disposed in upper portion 722 of shield 706.

In an aspect, upper vent 742 can be a polygon, such as a trapezoid. In another aspect, upper vent 742 can be rectangular. In another aspect, upper vent 742 can be ovular. In another aspect, upper vent 742 can be circular, as shown in FIG. 11 (depicting circular upper vents 1142).

FIG. 7A shows example dimensions (e.g., d_{T}, d_{S}, etc.) of the components of eyewear 700.

A distance d_{T} can be the distance between edge 719 and distal end 739. A distance dₛ can be the distance shield 706 extends from frame 702. In an aspect, d_{S} can be greater than about one-fifteenth d_{T}, such as about one-fifth to about one-fifteenth d_{T}, about one-sixth to about one-twelfth d_{T}, or about one-seventh to about one-tenth d_{T}.

The lens width w_{L} can be the length of a horizontal line Lₕ extending through the center point 705 of lens 704. In an aspect, the upper vent width w_{UV} can be greater than about one-tenth w_{L}, such as greater than about one-eighth w_{L}, greater than about one-sixth w_{L}, greater than about one-fourth w_{L}, or greater than about one-third w_{L}.

The lens height h_{L} can be the length of a vertical line L_{V} extending through the center point 705 of lens 704. In an aspect, the upper vent height h_{UV} can be greater than about one-thirtieth h_{L}, such as greater than about one-twenty-fifth h_{L}, greater than about one-twentieth h_{L}, greater than about one-fifteenth h_{L}, or greater than about one-tenth h_{L}.

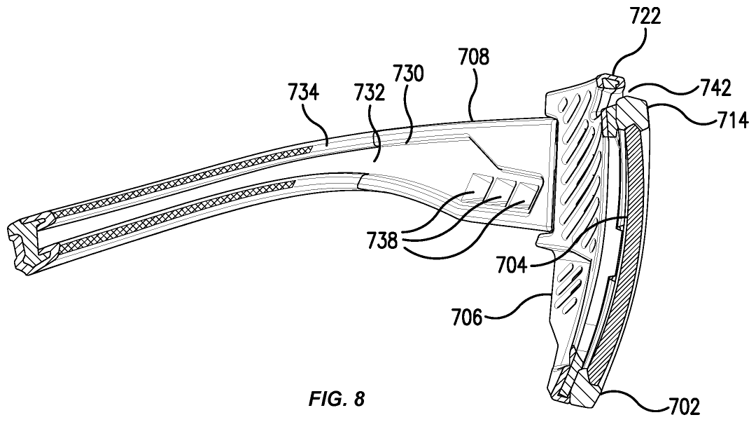

FIG. 8 shows a section of frame 702 with shield 706 attached. In an aspect, upper vent 742 can be defined by a surface of upper portion 722 and an adjacent surface of top portion 714 of frame 702. In another aspect, upper vent 742 can be formed entirely within upper portion 722, as shown in FIG. 11 (depicting upper vents 1142 formed entirely within upper portion 1122).

Upper vent 742 can be angled or shaped such that light, fluid, or projectiles passing through upper vent 742 are directed away from a wearer's eye and the inner surface of lens 704. Directing light away from the inner surface of lens 704 can prevent reflected light from entering a wearer's eye.

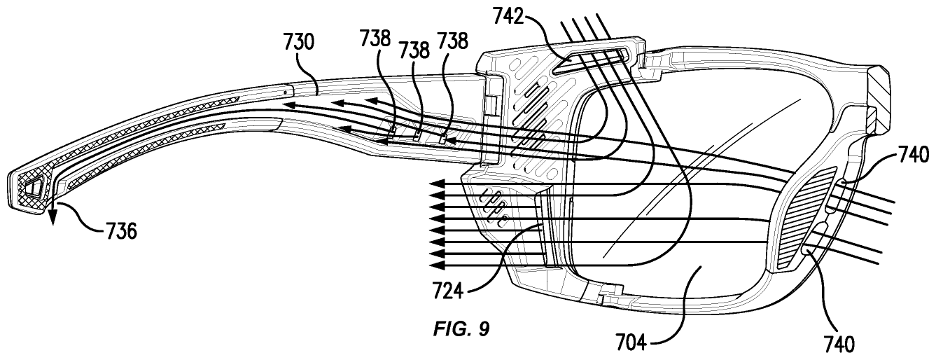

FIG. 9 shows an example pattern of airflow across eyewear 700, facilitated by lower vent 724, upper vent 742, temple vents 738, and nosepad vents 740. It should be understood that FIG. 9 only shows one possible pattern of airflow across eyewear 700, and other possible patterns of airflow exist depending on conditions such as wearer movement, wind direction and intensity, etc.

Lower vent 724, upper vent 742, temple vents 738, and nosepad vents 740 can direct air across the inner surface of lens 704 and into channel 730. For example, nosepad vents 740 can direct air into the region behind lens 704 and toward the inner surface of lens 704. Upper vent 742 and lower vent 724 can direct airflow into the region behind lens 704, contributing to a current of air across the inner surface of lens 704. For example, upper vent 742 and lower vent 724 can contribute to a current of air across the inner surface of lens 704 by reducing the pressure of air flowing through upper vent 742 and lower vent 724, for example according to the Venturi effect. This pressure decrease in the areas surrounding upper vent 742 and lower vent 724 can pull air across the inner surface of lens 704, thereby increasing the volume of air flowing across the inner surface of lens 704. Further, air directed across the inner surface of lens 704 can flow across shield 706 and/or into channel 730, thereby increasing the volume of air flowing through channel 730. Upper vent 742 can also provide an entryway for air to flow into channel 730, since upper vent 742 is disposed nearby channel 130.

Additionally, temple vents 738 can direct airflow into the region behind lens 704 (e.g., into channel 730), further contributing to the current of air across the inner surface of lens 704, for example according to the Venturi effect. Airflow directed into channel 730 can wick moisture along channel 730 and exit at opening 736.

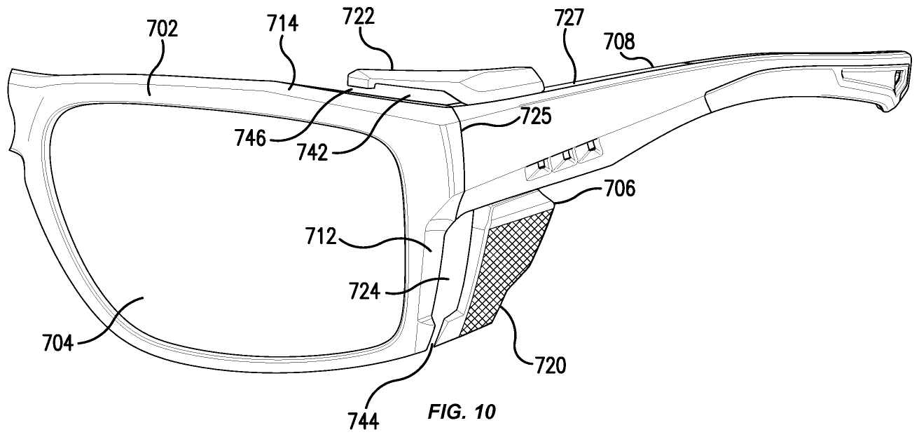

FIG. 10 shows a portion of eyewear 700 and shield 706 according to another aspect. As shown in FIG. 10, shield 706 can be removably attached to and be supported by temple 708 rather than frame 702. Shield 706 can be attached to temple 108 by any suitable attachment means, such as press- or snap-fit using at least one pin (or protrusion) and aperture or at least one slot and hook. In another aspect, as discussed above, shield 706 can be attached to temple 708 using magnets.

As shown in FIG. 10, rather than abutting frame 702, shield 706 can abut temple 708. For example, upper portion 722 of shield 706 can abut top portion 727 of temple 708. Further, shield 706 can be proximate frame 702 with a small gap therebetween at regions 744, 746 as shown, and thus shield 706 can be distanced from side portion 712 and top portion 714 of frame 702. The space between lower portion 720 of shield 706 and side portion 712 of frame 702 can be lower vent 724. The space between upper portion 722 of shield 706 and upper portion 714 of frame 702 can be upper vent 742. Optionally, shield 706 can also abut frame 702 at region 744 and/or region 746 (see FIG. 7 showing shield 706 abutting frame 702 at these respective regions).

Eyewear 700 shown in FIG. 10 can exhibit substantially the same functions and dimensions as eyewear 700 shown in FIG. 7 and/or eyewear 100.

FIG. 11 shows shield 1106. Shield 1106 can be substantially the same as shield 106 and shield 706. For example, shield 1106 can include substantially the same shield attachment features as those described above for shield 106 with reference to FIGS. 4B, 5, and 6 and the corresponding disclosure. Shield 1106 can include multiple lower vents 1124 and multiple upper vents 1142. When shield 1106 is attached to eyewear, lower vents 1124 and upper vents 1142 can facilitate airflow over the inner surface of a lens of the eyewear, leading to decreased fogging. Further, lower vents 1124 and upper vents 1142 can facilitate airflow in the region between the lens and a wearer's head, increasing moisture management and wearer comfort. Lower vents 1124 can be disposed in lower portion 1120 of shield 1106. Upper vents 1142 can be disposed in upper portion 1122 of shield 1106. In an aspect, one or more of lower vents 1124 can be formed entirely within lower portion 1120. In an aspect, one or more of upper vents 1142 can be formed entirely within upper portion 1122.

While FIG. 11 shows two lower vents 1124, shield 1106 can include additional lower vents 1124, such as three, four, five, or six lower vents 1124. While FIG. 11 shows three upper vents 1142, shield 1106 can include fewer or additional upper vents 1142, such as two, four, five, six, seven, or eight upper vents 1142.

In an aspect, lower vents 1124 can be of the same shape and dimensions. In another aspect, lower vents 1124 can be of differing shapes and dimensions. In an aspect upper vents 1142 can be of the same shape and dimensions. In another aspect, upper vents 1142 can be of differing shapes and dimensions.

### CONCLUSION

The aspect(s) described, and references in the specification to “one aspect,” “an aspect,” “an example aspect,” “an exemplary aspect,” etc., indicate that the aspect(s) described can include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it is understood that it is within the knowledge of one skilled in the art to affect such feature, structure, or characteristic in connection with other aspects whether or not explicitly described.

Spatially relative terms, such as “beneath,” “below,” “lower,” “above,” “on,” “upper” and the like, can be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus can be otherwise oriented (rotated 90 degrees or at other orientations) and the spatially relative descriptors used herein can likewise be interpreted accordingly.

The term “about” or “substantially” or “approximately” as used herein means the value of a given quantity that can vary based on a particular technology. Based on the particular technology, the term “about” or “substantially” or “approximately” can indicate a value of a given quantity that varies within, for example, 0.1-10% of the value (e.g., ±0.1%, ±1%, ±2%, ±5%, or ±10% of the value).

Numerical values, including endpoints of ranges, can be expressed herein as approximations preceded by the term “about,” “substantially,” “approximately,” or the like. In such cases, other aspects include the particular numerical values. Regardless of whether a numerical value is expressed as an approximation, two aspects are included in this disclosure: one expressed as an approximation, and another not expressed as an approximation. It will be further understood that an endpoint of each range is significant both in relation to another endpoint, and independently of another endpoint.

The foregoing description of the specific aspects will so fully reveal the general nature of the aspects that others can, by applying knowledge within the skill of the art, readily modify and/or adapt for various applications such specific aspects, without undue experimentation, without departing from the general concept of the aspects. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The breadth and scope of the aspects should not be limited by any of the above-described exemplary aspects, but should be defined only in accordance with the following claims and their equivalents.

What is claimed is:

1. Eyewear, comprising:
a frame;
a lens comprising an inner surface facing an eye of a wearer in an as-worn configuration;
a temple attached to the frame; and
a shield removably attached to the frame, the shield comprising:
a lower portion abutting a side portion of the frame,
an upper portion abutting a top portion of the frame,
a lower vent, and
an upper vent.

2. The eyewear of claim 1, the shield further comprising a depression to receive at least one of the frame or the temple.

3. The eyewear of claim 1, further comprising:
a fluid channel extending along an inner surface of the temple, the inner surface of the temple facing the head of the wearer in an as-worn configuration,
wherein the fluid channel comprises a bottom surface bordered by a wall, and
wherein the wall terminates at an opening disposed beyond an ear of the wearer in a direction away from the frame.

4. The eyewear of claim 3, wherein the temple comprises a temple vent disposed through the bottom surface of the fluid channel.

5. The eyewear of claim 4, further comprising a nosepad,
the nosepad comprising a nosepad vent.

6. The eyewear of claim 5, wherein the lower vent, the upper vent, the temple vent, and the nosepad vent direct air across the inner surface of the lens and into the fluid channel.

7. The eyewear of claim 1, wherein the upper vent and the lower vent increase the volume of air flowing across the inner surface of the lens and through the fluid channel according to the Venturi effect.

8. The eyewear of claim 1, further comprising an anti-skid portion disposed on a top portion of the eyewear and extending beyond the top portion of the eyewear, the coefficient of friction between the anti-skid portion and a surface being greater than the coefficient of friction between the top portion of the eyewear and the surface.

9. The eyewear of claim 8, wherein the upper portion of the shield comprises the anti-skid portion.

10. The eyewear of claim 1, the frame further comprising an aperture, and
the shield further comprising a pin to detachably attach to the aperture such that the pin is rotatable within the aperture.

11. The eyewear of claim 1, the frame further comprising a slot, and
the shield further comprising a hook to releasably engage the slot.

12. The eyewear of claim 1, wherein the lower vent is defined by a surface of the lower portion of the shield and an adjacent surface of the side portion of the frame.

13. The eyewear of claim 1, wherein the upper vent is defined by a surface of the upper portion of the shield and an adjacent surface of the top portion of the frame.

14. The eyewear of claim 1, wherein the temple is attached to the frame by a hinge, and the shield further comprises a recess to accommodate the temple when the temple is rotated relative to the frame.

15. The eyewear of claim 1, wherein the height of the lower vent is greater than about one-tenth the height of the lens.

16. The eyewear of claim 1, wherein the width of the upper vent is greater than about one-tenth the width of the lens.

17. A method of manufacturing eyewear with a removable side shield, comprising:
forming a frame;
forming a temple;
attaching the temple to the frame;
forming a shield of flexible material, the shield comprising:
a vent, and
a depression to receive at least one of the frame or the temple; and
removably attaching the shield such that the shield abuts a side portion of the frame.

18. The method of claim 17, wherein forming the shield comprises injection molding the shield.

19. Eyewear, comprising:
a frame;
a lens comprising an inner surface facing an eye of a wearer in an as-worn configuration;
a temple attached to the frame; and
a shield removably attached to the frame or the temple, the shield forming a vent.

20. The eyewear of claim 19, wherein the shield is proximate a side portion of the frame.

21. The eyewear of claim 19, wherein the shield abuts a side portion of the frame.

22. The eyewear of claim 19, wherein the temple is attached to the frame by a hinge.

23. The eyewear of claim 19, wherein the shield is configured to rotate with respect to the frame between an extended position and a closed position.

24. The eyewear of claim 19, further comprising:
a fluid channel extending along an inner surface of the temple, the inner surface of the temple facing the head of the wearer in an as-worn configuration,
wherein the fluid channel comprises a bottom surface bordered by a wall, and
wherein the wall terminates at an opening disposed beyond an ear of the wearer in a direction away from the frame.

25. The eyewear of claim 24, the temple further comprising a temple vent disposed through the bottom surface of the fluid channel.

26. The eyewear of claim 25, further comprising a nosepad,
the nosepad comprising a nosepad vent.

27. The eyewear of claim 26, wherein the vent, the temple vent, and the nosepad vent direct air across the inner surface of the lens and into the fluid channel.

28. The eyewear of claim 19, wherein the vent increases the volume of air flowing across the inner surface of the lens and through the fluid channel according to the Venturi effect.

29. The eyewear of claim 19, further comprising an anti-skid portion disposed on a top portion of the eyewear and extending beyond the top portion of the eyewear, the coefficient of friction between the anti-skid portion and a surface being greater than the coefficient of friction between the top portion of the eyewear and the surface.

30. The eyewear of claim 29, the shield further comprising an upper portion abutting at least one of a top portion of the frame or a top portion of the temple,
wherein the upper portion comprises the anti-skid portion.

31. The eyewear of claim 19, the frame or the temple further comprising an aperture, and
the shield further comprising a pin to detachably attach to the aperture such that the pin is rotatable within the aperture.

32. The eyewear of claim 19, the frame or the temple further comprising a slot, and
the shield further comprising a hook to releasably engage the slot.

33. The eyewear of claim 19, wherein the vent is defined by a surface of the shield and an adjacent surface of the side portion of the frame.

34. The eyewear of claim 19, wherein the height of the vent is greater than about one-tenth the height of the lens.

35. The eyewear of claim 19, wherein the vent is formed entirely within the shield.
